(19) United States
(12) Patent Application Publication
(10) Pub. No.: US 2010/0066412 A1
(43) Pub. Date: Mar. 18, 2010

(54) Method and Device for Recording Values of a Signal

(76) Inventor: Andreas Bode, Höchstadt A.D. Aisch (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/226,072

(22) PCT Filed: Feb. 21, 2007
(86) PCT No.: PCT/EP2007/051671

§ 371 Date: Dec. 2, 2009

(30) Foreign Application Priority Data
Apr. 7, 2006 (EP) 06007401.0

(51) Int. Cl. G11B 20/00

(52) U.S. Cl. 327/50

(57) ABSTRACT

The present invention relates to a method and an apparatus for reducing the quantity of values of a sampled signal which need to be stored. A value of the signal is stored if the value is outside, or at the edge of a, predefined value range whose size is determined by an upper limiting value and a lower limiting value. According to the invention, the size of the value range is changed, in particular is continuously reduced to zero, staring from a predefined starting size of the value range, which the values are being recorded.

### CROSS REFERENCE TO RELATED APPLICATIONS

This application is the US National Stage of International Application No. PCT/EP2007/051671, filed Feb. 21, 2007 and claims the benefit thereof. The International Application claims the benefits of European application No. 06007401.0 filed Apr. 7, 2006, both of the applications are incorporated by reference herein in their entirety.

### FIELD OF INVENTION

The present invention relates to a method for recording values of a signal, wherein a value of the signal is stored if the value lies outside or at the limit of a predefined value range whose size is determined by an upper limit value and a lower limit value. The present invention further relates to a device for recording values of a signal, wherein the device has a control means which is embodied in such a way that it stores a value of the signal if the value lies outside or at the limit of a predefined value range whose size is determined by an upper limit value and a lower limit value.

### BACKGROUND OF THE INVENTION

When values of a signal are being recorded or a signal is being sampled, it is desirable in many applications to limit the number of values or the volume of data to be stored in relation to the signal in order to minimize the amount of memory required for that purpose. Compression methods permit this. The stored volume of values or data is reduced or kept small without important signal-related information contained in the recorded and stored values being lost. At the same time it is usually desirable to record rapid changes in the signal in a timely manner, precise values in the case of minor changes, and structures contained in the signal, such as e.g. drifting, ramping and noise.

With known solutions, when values of the signal are recorded, the values are stored at fixed time intervals. In addition, values lying in a specific value range are not stored. This is intended to keep the number of stored values small by storing only changes of the signal that exceed a minimum change predefined by the value range. The size of the value range is specified by means of an upper and a lower limit value. The size of the value range remains constant over the entire course of the recording of the values. Thus, a new value is stored when the new value deviates from a preceding value by at least the upper or lower limit value. The storing function is performed when the new value that is to be stored lies outside of the predefined value range. A value range of said kind is also referred to as a deadband.

FIG. 1 shows an example of a noisy, essentially sinusoidal signal 1. FIG. 1 shows a coordinate system in which the waveform of the signal 1 is plotted over time. The signal 1 is sampled in the above-described conventional manner, with values of the signal 1 being recorded and stored. In FIG. 1 the stored values are indicated by means of a square marker. Values 2, 3 and 4 recorded and stored in the course of the signal 1 are identified more closely by way of example. The values are stored using predefined value ranges. The value ranges are depicted by a dotted outline in FIG. 1. Value ranges 5, 6 and 7 are identified more closely in FIG. 1. In their time extension the value ranges describe rectangular areas. The sizes of the value ranges are indicated by their extension in the vertical direction, i.e. in the ordinate direction. As can be seen in FIG. 1, the sizes of the value ranges are the same in each case over their progression in time. The sizes of the value ranges 5-7 are identified by a reference sign 8 in FIG. 1. The respective time extension of the individual value ranges is determined by the course of the signal 1. The propagation in time of the respective value ranges can vary. A stored value of the signal determines the position of the next value range. The upper and lower limit values of the next value range are specified symmetrically around the stored value. The upper limit value is therefore the same distance away from the stored value in the upward direction, i.e. in the positive ordinate direction, as the lower limit value in the downward direction, i.e. in the negative ordinate direction. In FIG. 1 the value range 5 is located symmetrically around the value 2. In the example according to FIG. 1 the signal 1 is sampled with the value range 5 until a value is recorded which lies outside or at the limit of the value range 5. This is the case with the value 3 in FIG. 1. Accordingly the value 3 is stored. The propagation in time of the value range 5 is identified by a reference sign 9 in FIG. 1. The position of the value 3 now serves as a starting point for the following value range 6. The upper and lower limit values of the value range 6 are specified symmetrically with respect to the value 3. The signal 1 is sampled with the value range 6 until a value is recorded which lies outside or at the limit of the value range 6. This is the case with the value 4. The value 4 is stored. The propagation in time of the value range 6 is identified by a reference sign 10 in FIG. 1. The value 4 serves as a starting point for the next value range 7. The further sampling and recording of the signal 1 and the storing of further values of the signal 1 are then carried out in the same way as described in connection with the values 2-4 and the value ranges 5-7.

With this approach to the recording of values of a signal the problem occurs that in order to record in particular small signal changes the constant size of the value range must be set very small. In the case an extremely noisy signal, such as for example the signal according to FIG. 1, either the compression rate is then unsatisfactory, i.e. lots of data is stored, with the result that the amount of memory required for that purpose is very large, or the signal waveform is not mapped sufficiently accurately by the stored values. Furthermore, parameters for recording the values of the signal must be taken into account already before the value range is set, even though the signal structures that are to be mapped are not known. This can also lead to unsatisfactory results during compression.

### SUMMARY OF INVENTION

The object underlying the present invention is to enable values of a signal to be recorded such that a number of stored values is kept small and the structure of the signal is reproduced with sufficient accuracy by the stored values.

This object is achieved by the technical teaching of the claims.

On the method side, starting from a predefined starting size of the value range, the size of the value range is changed while the values are being recorded. On the device side, the control means is furthermore embodied in such a way that, starting from a predefined starting size, it changes the size of the value range during the recording of the values. According to the invention, therefore, the value range is specified dynamically while the values are being recorded. The value range is also referred to as the deadband. The deadband is variable in this case. As a result a sometimes considerable reduction in the volume of stored values is ensured while at the same time the waveform of the signal is effectively mapped by means of the stored values.

In an advantageous embodiment of the invention the size of the value range reassumes the starting size following a change when a value has been stored. This enables large signal changes to be detected very quickly.

In a further particularly advantageous embodiment the size of the value range is reduced, in particular continuously. By this means it is possible to identify a large signal change quickly, in particular immediately, and in addition also detect small signal changes. Slow signal drifting and ramping are detected as such and recorded. Furthermore, an extremely noisy signal can be recognized as such without many values of the noisy signal being stored. Signal peaks are quick to detect even in a noisy signal. An average signal change scan advantageously be detected all the more easily the stronger it is.

Advantageously, a value will also be stored when a predefined minimum size of the value range is reached as the value range is being reduced in size and no value of the signal lying outside or at the limit of the reduced value range has yet been recorded. This ensures that even with the predefined minimum size a value will be stored irrespective of whether it lies inside the value range. As a result the actual signal waveform and its changes can be mapped even more accurately in the stored values.

The predefined minimum size of the value range is particularly preferably set equal to zero. In this case a deadband or a value range is no longer present if the minimum size is present. The exact value of the signal is therefore stored.

In an advantageous embodiment the upper limit value and the lower limit value are changed symmetrically when the size of the value range is changed. The upper and lower limit values are therefore changed in the same way.

In a further advantageous embodiment the size of the value range is changed in accordance with a linear function. This ensures a particularly good compromise between fast and accurate recording and storing of signal changes.

The value range is preferably specified as a function of a previously stored value of the signal, in particular a value stored immediately previously. This likewise ensures a fast and at the same time accurate recording and storing of signal changes.

The value range is particularly advantageously specified as a function of a predicted value that is determined on the basis of the previously recorded values of the signal. This embodiment of the invention ensures a particularly precise alignment of the value range with the signal waveform. Signal changes are recorded particularly effectively, accurately and quickly.

A number, in particular a maximum number, of values to be stored in a predefined first time range of the signal is preferably predefined. By this means it can be ensured that the memory area required for storing values of the signal is precisely specified and used. The first time range can include for example a specific time in the course of the signal at which values are regularly stored. A desired average number of values to be stored can thus be specified for example.

Furthermore, the starting size of the value range is preferably specified as a function of values stored during a predefined second time range of the signal. The second time range can be for example a specific number of monitoring cycles for the recording of the values. The starting size can advantageously be aligned to the previously recorded and stored signal waveform. This enables an even more effective and faster recording of signal changes.

### BRIEF DESCRIPTION OF THE DRAWINGS

The invention and its advantages are explained in more detail below with the aid of examples and exemplary embodiments and with reference to the accompanying drawing, in which:

FIG. 1 shows an example of the recording of values of a signal according to the prior art,

FIG. 2 shows an exemplary embodiment of a device according to the invention for recording values of a signal,

FIG. 3 shows an exemplary embodiment of the recording of values in the case of an extremely noisy signal,

FIG. 4 shows an exemplary embodiment of the recording of values in the case of a signal peak in a noisy signal,

FIG. 5 shows an exemplary embodiment of the recording of values in the case of a slightly noisy signal,

FIG. 6 shows an exemplary embodiment of the recording of values in the case of a slightly drifting signal, and

FIG. 7 shows an exemplary embodiment of the recording of values in the case of a strong change in a signal.

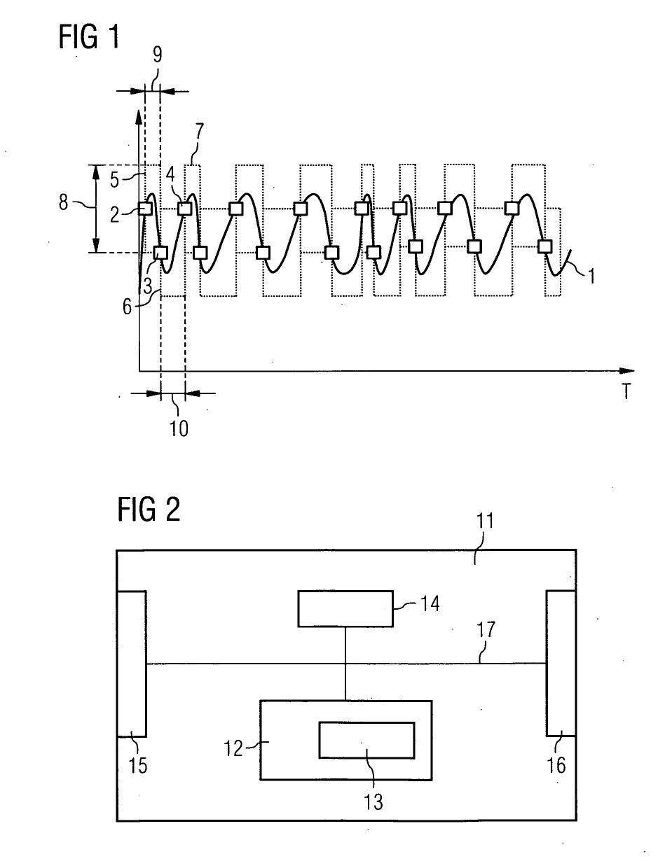

### DETAILED DESCRIPTION OF INVENTION

FIG. 2 shows an exemplary embodiment of a device 11 according to the invention for recording values of a signal. The device 11 includes a control means 12 having a program memory 13, a data memory 14, an input interface 15 and an output interface 16. These components of the device are connected to one another via a bus 17. A signal that is to be sampled and whose values are to be recorded is supplied to the device 11 via the input interface 15. In the process values of the signal are to be stored in the data memory 14 if the values reach or exceed a limit of a specified value range. A change in the signal compared to a previously recorded and stored value is thereby to be identified and stored. At the same time the change should where appropriate be sufficiently large to keep the volume of values to be stored small, and nevertheless where appropriate be sufficiently small to register an accurate image of the signal with its structures in the stored values. For that purpose the signal is supplied to the control means 12 which processes the signal accordingly. Parameters for processing the signal, in particular for specifying the value range and its size, are likewise supplied to the control means 12 via the input interface 15. Said parameters, together with a program stored in the program memory 13, control the control means 12 in a suitable manner.

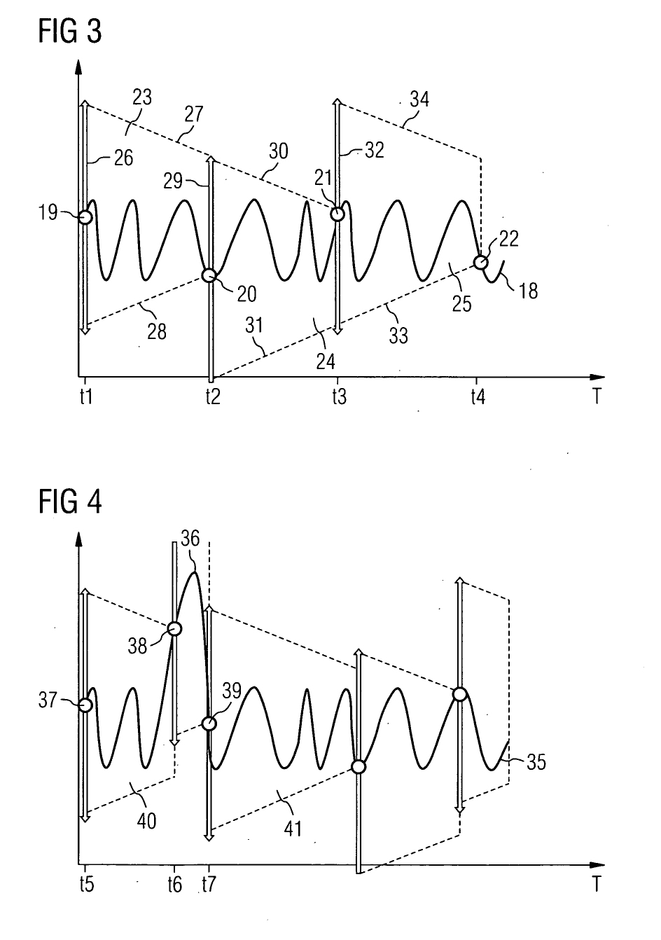

According to the invention the value ranges for storing the values of the signal are changed. The value ranges are therefore variable. FIG. 3 shows an exemplary embodiment of the recording of values of a signal 18. The signal 18 is an extremely noisy, essentially sinusoidal signal whose progression over time is plotted in a coordinate system. The signal 18 is sampled by means of the device 11, with values of the signal 18 that lie at the limit or outside of a specified variable value range being recorded. These values are stored in the data memory 14. Stored values 19, 20, 21 and 22 are labeled by means of a round marker in FIG. 3. FIG. 3 also shows value ranges 23, 24 and 25 which in their time extension describe trapezoidal areas that are identified by means of dash-dotted lines. The sizes of the value ranges 23-25 change in their respective variation with time.

The value 19 is recorded and stored at a point in time t1 of the course of the signal 18. The value 19 serves as a starting point for the recording of values of the signal 18 as shown in FIG. 3. The position of the value 19 determines the position of the following value range 23. The value range 23 has a starting size 26 which is specified by means of an upper limit value 27 and a lower limit value 28. In the case of the starting size 26 the upper limit value 27 is the same distance away from the stored value 19 in the upward direction, i.e. in the positive ordinate direction, as the lower limit value 28 in the downward direction, i.e. in the negative ordinate direction. In FIG. 3 the value range 23 is initially located symmetrically around the value 19. The starting size 26 is indicated in FIG. 3 by a double arrow running vertically through the value 19 in the ordinate direction. Starting from the starting size 26 the size of the value range 23 is then reduced. In this case the size is reduced continuously in accordance with a predefined linear function. The upper limit value 27 is lowered in the variation with time in accordance with a linear function with negative slope and the lower limit value 28 is increased in the variation with time in accordance with a linear function with positive slope, with the slopes of the two functions being oppositely equal. The upper limit value 27 and the lower limit value 28 are changed symmetrically.

As a result of the reduction in the size of the value range 23 the signal 18 hits the lower limit value 28 of the value range 23 at a point in time t2. At the point in time t2 the value 20 of the signal 18 is recorded and stored. In the time range between the points in time t1 and t2 the signal 18 is less than the upper limit value 27 set in each case and greater than the lower limit value 28 set in each case. Consequently no value of the signal 18 lying in this time range is stored. The storing of the value 20 causes the next value range 24 to be specified. In this case the value range 24 initially assumes a starting size 29 which corresponds to the starting size 26. After a new value has been stored, the value range previously reduced in size is therefore increased in size again. In particular it is reset to an original starting size. The position of the value 20 determines the position of the value range 24. The starting size 29 is specified by means of an upper limit value 30 and a lower limit value 31. In the case of the starting size 29 the upper limit value 30 is the same distance away from the stored value 20 upwards in the positive ordinate direction as the lower limit value 31 downwards in the negative ordinate direction. The value range 24 is initially located symmetrically around the value 20. The starting size 29 is indicated by means of a double arrow running vertically through the value 20 in the ordinate direction. Starting from the starting size 29 the size of the value range 24 is then reduced. In this case the size is reduced continuously in accordance with a predefined linear function. The size of the value range 24 is changed analogously to the previously described changing in size of the value range 23.

As a result of the reduction in the size of the value range 24 the signal 18 hits the upper limit value 30 of the value range 24 at a point in time t3. At the point in time t3 the value 21 is recorded and stored. In the time range between the points in time t2 and t3 the signal 18 is less than the upper limit value 30 set in the individual case and greater than the lower limit value 31 set in the individual case. Consequently no value of the signal 18 lying in this time range is stored. The storing of the value 21 causes the next value range 25 to be specified. The value range 25 in this case assumes a starting size 32 which corresponds to the starting sizes 26 and 29. As described previously in connection with the value ranges 23 and 24, in the variation with time of the signal 18 the size of the value range is then reduced in size continuously by means of a linear function.

This continues until the signal 18 hits a lower limit value 33 of the value range 25 at a point in time t4. At the point in time t4 the value 22 is recorded and stored. In the time range between the points in time t3 and t4 the signal 18 is less than an upper limit value 34 of the value range 25 set in each case and greater than the lower limit value 33 set in each case. Consequently no value of the signal 18 lying in this time range is stored.

As a result of the reduction in the sizes of the value ranges 23-25 the number of values to be stored in the case of the extremely noisy signal 18 can be kept very small. At the same time a good mapping of the noise is ensured by means of the stored values.

FIG. 4 shows an exemplary embodiment of the recording of values in a noisy signal 35 that has a signal peak 36. In FIG. 4, as previously in FIG. 3, several values of the signal 35 are identified by means of round markers. Said marked values are stored in the data memory 14 by the control means 12. Stored values 37, 38 and 39 are identified more closely in FIG. 4 by way of example. The value 37 is recorded and stored at a point in time t5 of the waveform of the signal 35. The value 37 serves as a starting point for the recording of values of the signal 35 as illustrated in FIG. 4. The position of the value 37 determines the position of a following value range 40. The value range 40 has a starting size which corresponds to those of the value ranges 25-27 according to FIG. 3 and is specified by means of an upper limit value and a lower limit value. The size of the value range 40 is reduced as described previously with reference to FIG. 3.

At a point in time t6 the signal 35 hits the upper limit value of the value range 40. At the point in time t6 the value 38 that the signal 35 has at this point in time t6 is recorded and stored. In the time range between the points in time t5 and t6 the signal 35 is less than the upper limit value of the value range 40 set in each case and greater than its lower limit value set in each case. Consequently no value of the signal 35 lying in this time range is stored.

The position of the value 38 determines the position of a following value range 41. The value range 41 has a starting size which corresponds to that of the value range 40 and is likewise specified by means of an upper limit value and a lower limit value. The size of the value range 41 is reduced, as previously in the case of the other value ranges. In its variation with time around the point in time t6 the signal 35 exhibits a rapid and strong rise up to the signal peak 36. The signal peak 36 represents a turning point in the course of the signal after which the signal drops away quickly. As a result the signal 35 very quickly hits the lower limit value of the value range 41. This happens at a point in time t7. At the point in time t7 the value 39 that the signal 35 has at this point in time t7 is recorded and stored. The position of the value 38 determines the position of a following value range. Further values of the signal 35 are recorded and stored analogously to the procedure according to FIG. 3.

The time range between the points in time t6 and t7 is very short because the signal 35 declines quickly. This strong signal change can be recorded quickly according to the invention. At the same the number of stored values is kept small and the noise and the signal peak 36 of the signal 35 are effectively recorded.

FIG. 5 shows an exemplary embodiment of the recording of values in the case of a slightly noisy signal 42. As a result of the reduction in the sizes of specified value ranges 43 and 44 for recording values of the signal 42 it is ensured in this case also that this slight noise is mapped sufficiently accurately by means of stored values 45, 46 and 47.

The sizes of the value ranges can be scaled down to a predefinable minimum size which advantageously corresponds to the size zero. The sizes of the value ranges can therefore be reduced to a point where a value range no longer exists at all. Then, provided a signal is still present, its value is precisely registered and stored. If the predefined minimum size of a value range is reached when its size is being reduced, the control means 12 controls a storing of the value of the signal that is then present.

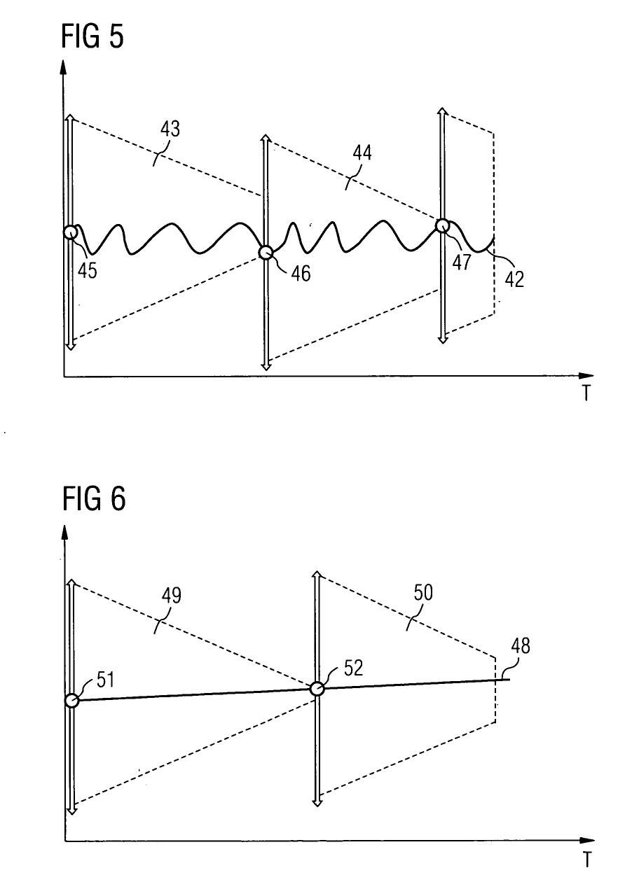

FIG. 6 shows an exemplary embodiment of the recording of values in the case of a weakly drifting signal 48. The signal 48 rises slightly in its course at a very low gradient. In a similar manner to the exemplary embodiment according to FIG. 5 it is ensured as a result of the reduction in the sizes of specified value ranges 49 and 50 in this case too that this weak drifting of the signal 48 is mapped sufficiently accurately by means of stored values 51 and 52. The size of the value range 49 is for that purpose reduced particularly strongly until the signal 48 hits an already greatly reduced (starting from its starting size) upper limit value of the value range 49. The value 52 of the signal 48 that is then present is stored.

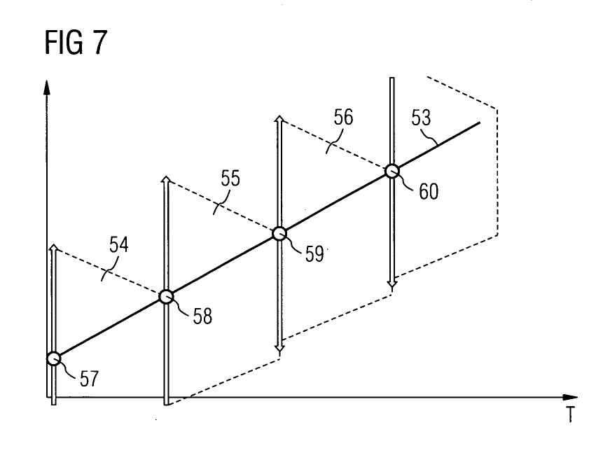

FIG. 7 shows an exemplary embodiment of the recording of values in the case of a strong change in a signal 53. The signal 53 is a strongly drifting signal rising with a steep gradient. The reduction in the sizes of specified value ranges 54, 55 and 56 ensures that this strong drifting of the signal 53 is quickly recorded and mapped by means of stored values 57, 58, 59 and 60. In the case of the values 57-60 the signal 53 hits an upper limit value of the value ranges 54-56 in each instance.

In the exemplary embodiments described hereintofore, the sizes of the value ranges are changed by means of a linear function. It is equally possibly to accomplish the change in another suitable manner. For example, the change can also be implemented by means of an exponential function. In addition, in the exemplary embodiments described, the upper limit values and the lower limit values of the respective value ranges are changed symmetrically. It is equally possible in this case to implement the changes in another suitable manner so that they are not oppositely identical. Furthermore, in particular the positions of the respective value ranges are specified as a function of values of the signal that were stored immediately previously. It is, however, also possible to specify the value ranges as a function of predicted future values which are determined on the basis of previously recorded values of the signal by means of which the structure of the signal is mapped.

1-12. (canceled)

13. A method for recording values of a signal, comprising:
predefining a value range size by an upper limit value and a lower limit value for a stored value of a signal;
starting from the predefined starting size of the value range, continuously reducing the value range size during the recording of the values; and
storing the value of the signal if the signal value lies or at the limit of the predefined value range.

14. The method as claimed in claim 13, wherein the size of the value range reassumes the starting size after a value has been stored.

15. The method as claimed in claim 14, wherein a value is also stored when, during the reduction in size of the value, a predefined minimum size of the value range is reached and no value of the signal lying outside or at the limit of the scaled-down value range has yet been recorded.

16. The method as claimed in claim 15, wherein the predefined minimum size of the value range is equal to zero.

17. The method as claimed in claim 16, wherein during the changing of the size of the value range the upper limit value and the lower limit value are changed symmetrically.

18. The method as claimed in claim 17, wherein the size of the value range is changed in accordance with a linear function.

19. The method as claimed in claim 18, wherein the value range is specified as a function of a stored value of the signal.

20. The method as claimed in claim 18, wherein the value range is specified as a value stored immediately previously.

21. The method as claimed in claim 20, wherein the value range is specified as a function of a predicted value determined on the basis of the values of the signal that have been recorded.

22. The method as claimed in claim 21, wherein a number of values to be stored in a predefined first time range of the signal is predefined.

23. The method as claimed in claim 21, wherein a maximum number of values to be stored in a predefined first time range of the signal is predefined.

24. The method as claimed in claim 23, wherein the starting size of the value range is specified as a function of values stored during a predefined second time range of the signal.

25. A device for recording values of a signal, comprising:
a determining device that determines if the signal value lies outside of a predetermined range;
a control device that controls the storage of the signal value if the value lies outside or at the limit of a predefined value range whose size is determined by an upper limit value and a lower limit value and starting from the predefined starting size, the predefined value range is continuously reduced during the recording of the values; and
a storage device that stores the signal values determined to be stored by the control device.

26. The device as claimed in claim 25, wherein the size of the value range reassumes the starting size after a value has been stored.

27. The device as claimed in claim 26, wherein a value is also stored when, during the reduction in size of the value, a predefined minimum size of the value range is reached and no value of the signal lying outside or at the limit of the scaled-down value range has yet been recorded.

28. The device as claimed in claim 27, wherein the predefined minimum size of the value range is equal to zero.

29. The device as claimed in claim 28, wherein during the changing of the size of the value range the upper limit value and the lower limit value are changed symmetrically.

30. The device as claimed in claim 29, wherein the size of the value range is changed in accordance with a linear function.

31. The device as claimed in claim 30, wherein the value range is specified as a function of a stored value of the signal.
